(19) United States
(12) Patent Application Publication
(10) Pub. No.: US 2015/0332094 A1
(43) Pub. Date: Nov. 19, 2015

(54) SMART GLASSES WITH REAR CAMERA

(71) Applicant: ELECTRONICS AND TELECOMMUNICATIONS RESEARCH INSTITUTE, Daejeon (KR)

(72) Inventors: Sung Ho IM, Daejeon (KR); Jae Guk GWON, Daejeon (KR); Do Hyung KIM, Daejeon (KR); Cheol RYU, Daejeon (KR); Jin Suk MA, Daejeon (KR); Jae Bok PARK, Daejeon (KR); Choong Bum PARK, Daejeon (KR); Seok Jin YOON, Daejeon (KR); Kyung Hee LEE, Daejeon (KR); Jae Ho LEE, Daejeon (KR); Hyung Seok LEE, Daejeon (KR)

(21) Appl. No.: 14/685,824

(22) Filed: Apr. 14, 2015

(30) Foreign Application Priority Data
May 13, 2014 (KR) 10-2014-0056964

(51) Int. Cl. G06K 9/00; H04N 5/225; G02B 27/01

(52) U.S. Cl. CPC G06K 9/00671; G02B 27/0172; H04N 5/2257; H04N 5/2253; G02B 2027/0178

(57) ABSTRACT

The present invention relates to smart glasses, and the smart glasses include: a frame mounted with lens; a pair of temples extended in one direction from both side ends of the frame so as to face each other; a rear camera mounted at an end of the temple and configured to photograph a rear image of a wearer; a display unit installed at one side of the lens and configured to display the rear image photographed by the rear camera; and a control device configured to control an operation of each of the constituent elements, thereby enabling a user to check a situation in the rear view without turning his/her head.

### CROSS-REFERENCE TO RELATED APPLICATIONS

This application claims priority to and the benefit of Korean Patent Application No. 10-2014-0056964 filed in the Korean Intellectual Property Office on May 13, 2014, the entire contents of which are incorporated herein by reference.

### TECHNICAL FIELD

The present invention relates to smart glasses including a camera, and more particularly, to smart glasses including a rear camera, which photographs a rear image by mounting the rear camera to the smart glasses, and displays the photographed rear image on lenses of the glasses or an external terminal to enable a wearer to recognize a situation in the rear view.

### BACKGROUND ART

Recently, as a smart phone becomes popular, and an interest on a wearable device is increased, research and development of smart, glasses worn on a head has been actively conducted. The smart glasses are a kind of head mounted display (HMD), and are a display device mounted on a head to directly present an image in front of the eyes of a user.

For example, Google glasses display a camera input on a lens of the glasses, and combine augmented reality with an image photographed by a camera, thereby attracting a lot of interests.

In the smart glasses in the related art, a camera is attached to a front surface of the glasses so as to observe a front side of a wearer, and photographs a front image to enable the wearer to view better a viewable region or the front image to be shared.

As described above, the smart glasses in the related art photograph and display the image of the front side entering the view of the wearer, so that the wearer cannot view a region deviating from the view of the wearer (for example, a rear region) still without turning the head.

### SUMMARY OF THE INVENTION

The present invention has been made in an effort to provide smart glasses including a rear camera, which photographs a rear image by mounting the rear camera to the smart glasses, and displays the photographed rear image on lenses of the glasses or an external terminal to enable a wearer to recognize a situation in the rear view.

The present invention has also been made in an effort to provide smart glasses including a rear camera, which is capable of adjusting a position and an angle of the rear camera according to a movement of a head of a user wearing the smart glasses.

Technical problems to be achieved by various exemplary embodiments of the present invention are not limited to the aforementioned technical problems, and other technical problems may be present.

An exemplary embodiment of the present invention provides smart glasses including a rear camera, including: a frame mounted with lens; a pair of temples extended in one direction from both side ends of the frame so as to face each other; a rear camera mounted at an end of the temple and configured to photograph a rear image of a wearer; a display unit installed at one side of the lens to display the rear image photographed by the rear camera; and a control device configured to control an operation of each of the constituent elements.

The smart glasses may further include: a camera supporter extended from a distal end of the temple in a rear direction and integrally formed with the temple; and a length adjustment valve configured to adjust a position of the rear camera 140 by longitudinally extending the camera supporter.

The rear camera may include: an image sensor configured to photograph the rear image; a vertical adjustment valve configured to adjust the image sensor in a vertical direction; and a horizontal adjustment valve configured to adjust the image sensor in a horizontal direction.

The control device may include: a processor; a wireless communication unit configured to transmit an image photographed by the rear camera to an external terminal through wireless communication under control of the processor; an input unit configured to receive an operation control command of the rear camera; and a power supply unit configured to supply power necessary for an operation of the smart glasses.

The wireless communication may be implemented by any one communication scheme of Bluetooth, near field communication, radio frequency identification (RFID), infrared communication, mobile communication, and wireless Internet.

The external terminal may be one or more of a smart phone, a tablet computer, a notebook computer, a display device, a storage device, and a mobile communication terminal.

The display unit may be integrally formed with the lens.

According to the exemplary embodiment of the present invention, the camera is mounted at a distal end of the temple to photograph a rear image, and a user may check the photographed image through the lens of the glasses or an external terminal, so that the user may check a situation in the rear view without turning his/her head. That is, the user may monitor another accompanying person at a rear side only by wearing the smart glasses while riding a cycle or climbing a mountain, and recognize a risk approaching from the rear side and handle the risk in advance, so that the present invention has an effect of providing safety and protecting a person.

According to the exemplary embodiment of the present invention, a user who cannot hear an external sound due to hearing impairment or wearing an earphone may recognize a situation in the rear view only by wearing the smart glasses, so that the present invention may provide safety to the user.

### BRIEF DESCRIPTION OF THE DRAWINGS

FIG. 1 is a front view illustrating smart glasses including a rear camera according to an exemplary embodiment of the present invention.

FIG. 2 is a lateral view illustrating the smart glasses including the rear camera according to the exemplary embodiment of the present invention.

FIG. 3 is a diagram illustrating a configuration of the rear camera illustrated in FIG. 1.

FIG. 4 is a block diagram illustrating the smart glasses including the rear camera according to the exemplary embodiment of the present invention.

FIG. 5 is a diagram illustrating an example of use of the smart glasses including the rear camera according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part, by the particular intended application and use environment.

In the figures, reference numbers refer to the same or equivalent parts of the present invention throughout the several figures of the drawing.

### DETAILED DESCRIPTION

Hereinafter, an exemplary embodiment of the present invention will be described in detail with reference to the accompanying drawings.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.

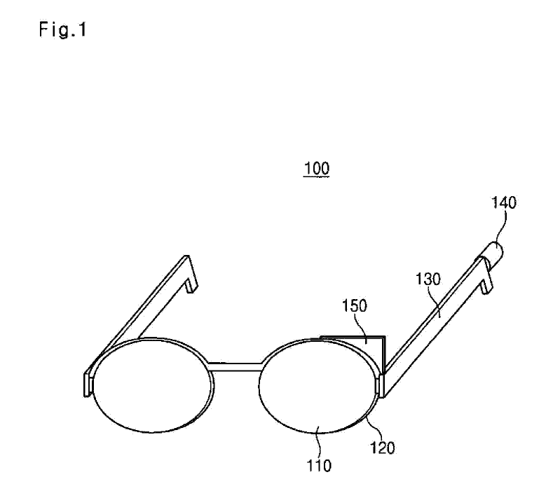

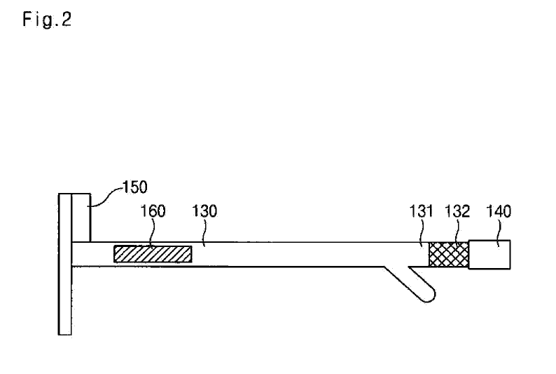

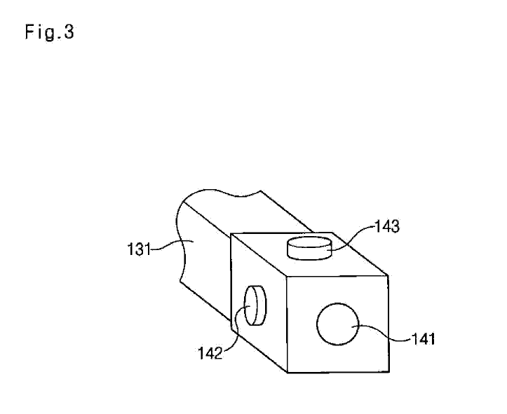

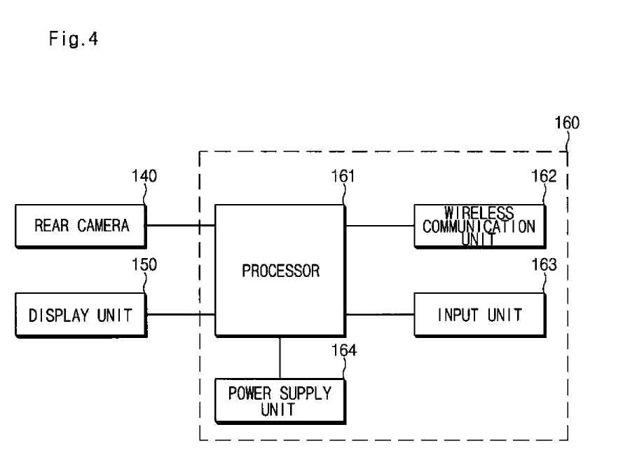

FIG. 1 is a front view illustrating smart glasses including a rear camera according to an exemplary embodiment of the present invention, FIG. 2 is a lateral view illustrating the smart glasses including the rear camera according to the exemplary embodiment of the present invention, FIG. 3 is a diagram illustrating a configuration of the rear camera illustrated in FIG. 1, and FIG. 4 is a block diagram illustrating the smart glasses including the rear camera according to the exemplary embodiment of the present invention.

Referring to the drawings, smart glasses 100 including a rear camera of the present invention includes a lens 110, a frame 120, temples 130, a rear camera 140, a display unit 150, and a control device 160.

The lens 110 has an optical property and is transparent, and is manufactured to have a shape in accordance with the frame 120.

The frame 120 serves to support the lens 110 and fix the lens 110 in front of the eyes.

The temples 130 are extended in one direction from both side ends of the frame 120 so as to face each other, and are configured as a pair. The temples 130 include glass tips which are extended to be bent from distal ends of the temples 130 in a down direction to prevent the smart glasses 100 from being hung on the ears and sliding down or being shaken.

A camera supporter 131 is extended from the distal end of the temple 130 in a rear direction to be integrally formed with the temple 130. The camera supporter 131 may be longitudinally extended by using a length adjustment valve 132 to adjust a position of the rear camera 140. Accordingly, in the present invention, the camera supporter 131 supporting the rear camera 140 is extended, so that it is easy to photograph a rear image, and it is possible to prevent the rear camera 140 from being obscured by hair.

The length adjustment valve 132 serves to adjust the position of the rear camera 140, and may adjust a distance between the ear of a wearer and the rear camera 140 so as to prevent the camera lens from being obscured by hair according to a state of a movement of the head of the wearer.

The rear camera 140 is mounted at an end of the camera supporter 131 so as to head toward the rear side to photograph the image of the rear side of the wearer of the glasses. As described above, the rear camera 140 is positioned at an end portion of the temple 130, so that it is easy to photograph the image of the rear side, and the rear camera 140 is installed to head for the same direction as that of the temple 130, thereby occupying a small space and being inconspicuous. Further, a photographing direction of the rear camera 140 is changed according to a movement of the head of the wearer, so that it is necessary to adjust a direction (angle) of the camera.

The rear camera 140 includes an image sensor 141 for photographing an image, a vertical adjustment valve 142, and a horizontal adjustment valve 143.

The image sensor 141 is a photographing device for converting an image into a digital signal according to intensity of light, and may be implemented by a complementary metal oxide semiconductor (CMOS) or a charge coupled device (CCD).

The vertical adjustment valve 142 adjusts the image sensor 141 in a vertical direction, and the horizontal adjustment valve 143 adjusts the image sensor 141 in a horizontal direction. In this case, the user adjusts a direction of the rear camera 140 by rotating the vertical adjustment valve 142 and/or the horizontal adjustment valve 143.

The display unit 150 may be installed so as to be spaced apart from the lens 110 at a predetermined interval or attached onto one side surface of the lens 110. The display unit 150 may be integrally manufactured with the lens 110. The display unit 150 may be implemented by a transparent display or a flexible transparent display.

The control device 160 is disposed inside the temple 130, and includes a processor 161, a wireless communication unit 162, an input unit 163, and a power supply unit 164. The control device 160 includes a storage medium (not illustrated) capable of, storing the photographed image.

The processor 161 outputs an image photographed through the rear camera 140 on the display unit 150 through signal processing.

The wireless communication unit 162 wirelessly communicates with an external terminal. Here, the wireless communication may adopt any one communication scheme of Bluetooth, near field communication (NFC), radio frequency identification (RFID), infrared communication, mobile communication, and wireless Internet.

The wireless communication unit 162 transmits a rear image output from the rear camera 140 to an external terminal under the control of the processor 161. The external terminal may be implemented by a smart phone, a tablet computer, a notebook computer, a display device, a storage device, and a mobile communication terminal.

The input unit 163 serves to receive a control command from the user, and may be implemented by a touch pad, a button, or voice recognition. For example, the input unit 163 transmits a photographing command or a stop command to the processor 161 according to a user input.

The power supply unit 164 photographs and displays the rear image, and supplies each constituent element with power necessary for performing a function, such as a function of transmitting the rear image through wireless communication. The power supply unit 164 may be implemented by a detachable battery or an embedded battery. The power supply unit 164 may include a charging/discharging circuit for charging and discharging a battery, and support wireless charging. Further, the power supply unit 164 may be disposed at an external side the temple 130.

In the foregoing exemplary embodiment, it is described that the position and the direction of the rear camera 140 are manually adjusted as an example, but the present invention may be implemented so that the position and the direction of the rear camera 140 are automatically adjusted.

When the position and the direction of the rear camera 140 are automatically adjusted, the processor 161 of the smart glasses 100 detects a posture of the rear camera 140 by using a gyro sensor, an acceleration sensor, and the like, and adjusts the direction of the rear camera 140 so that the rear camera 140 heads toward the rear direction according to the detected posture.

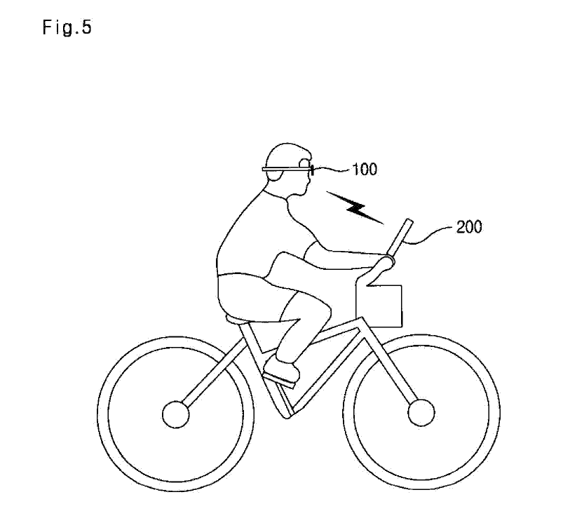

FIG. 5 is a diagram illustrating an example of use of the smart glasses including the rear camera according to the exemplary embodiment of the present invention.

As illustrated in FIG. 5, a user riding a bicycle may check a rear image photographed through the rear camera 140 provided on the smart glasses 100 through the display unit 150 attached to the lens 110.

Otherwise, the processor 161 of the smart glasses 100 transmits an image photographed through the rear camera 140 to an external terminal 200 through the wireless communication unit 162. The external terminal 200 receives the rear image transmitted from the smart glasses 100 and outputs the received rear image on a display screen. In this case, the external terminal 200 may store the received rear image in a memory.

As described above, the present invention photographs a rear image and provides the photographed rear image to a user wearing the smart glasses 100, so that when an accompanying person falls behind, the user may keep an eye on the falling-behind person through a rear image, and recognize a dangerous object, such as a vehicle, behind the user, and avoid the dangerous object.

All of the exemplary embodiments and conditional examples disclosed through the present specification have been described for illustrative purposes for helping those skilled in the art'to understand the principle and the concept of the present invention, and those skilled in the art will appreciate that the present invention may be implemented by modified forms within the scope without departing from the essential feature of the present invention. Accordingly, the disclosed, exemplary embodiments shall be considered in an illustrative aspect, not a limited aspect. The scope of the present invention is present in the claims, not the above description, and shall be construed that all differences within the scope equivalent to the claims belong to the present invention.

What is claimed is:

1. Smart glasses including a rear camera, comprising:
a frame mounted with lens;
a pair of temples extended in one direction from both side ends of the temples so as to face each other;
a rear camera mounted at an end of the frame to photograph a rear image of a wearer;
a display unit installed at one side of the lens and configured to display the rear image and configured to photographed by the rear camera; and
a control device configured to control an operation of each of the constituent elements.

2. The smart glasses of claim 1, further comprising:
a camera supporter extended from a distal end of the temple in a rear direction and integrally formed with the temple; and
a length adjustment valve configured to adjust a position of the rear camera 140 by longitudinally extending the camera supporter.

3. The smart glasses of claim 1, wherein the rear camera includes:
an image sensor configured to photograph the rear image;
a vertical adjustment valve configured to adjust the image sensor in a vertical direction; and
a horizontal adjustment valve configured to adjust the image sensor in a horizontal direction.

4. The smart glasses of claim 1, wherein the control device includes:
a processor;
a wireless communication unit configured to transmit an image photographed by the rear camera to an external terminal through wireless communication under control of the processor;
an input unit configured to receive an operation control command of the rear camera; and
a power supply unit configured to supply power necessary for an operation of the smart glasses.

5. The smart glasses of claim 4, wherein the wireless communication is implemented by any one communication scheme of Bluetooth, near field communication, radio frequency identification (RFID), infrared communication, mobile communication, and wireless Internet.

6. The smart glasses of claim 4, wherein the external terminal is one or more of a smart phone, a tablet computer, a notebook computer, a display device, a storage device, and a mobile communication terminal.

7. The smart glasses of claim 1, wherein the display unit is integrally formed with the lens.
